(19) United States
(12) Patent Application Publication
(10) Pub. No.: US 2018/0120472 A1
(43) Pub. Date: May 3, 2018

(54) APPARATUS AND METHOD FOR LOCALIZING UNDERWATER ANOMALOUS BODY

(71) Applicant: Korea Institute Of Geoscience And Mineral Resources, Daejeon (KR)

(72) Inventors: Hyo Sun LEE, Daejeon (KR); Hyun-Key JUNG, Daejeon (KR); Sung-Ho CHO, Daejeon (KR); Hyoung Rae RIM, Daejeon (KR)

(73) Assignee: Korea Institute Of Geoscience And Mineral Resources, Daejeon (KR)

(21) Appl. No.: 15/662,887

(22) Filed: Jul. 28, 2017

(30) Foreign Application Priority Data
Oct. 28, 2016 (KR) 10-2016-0142151

(51) Int. Cl. G01V 3/38; G01V 3/08; G01V 7/00

(52) U.S. Cl. CPC G01V 3/38; G01V 3/088; G01V 7/00; G01V 3/08

(57) ABSTRACT

The present disclosure relates to an apparatus and a method for localizing an underwater anomalous body, which detect, in real time, any one disturbed signal among a disturbed electric field, a disturbed magnetic field, and a disturbed gravity field by means of a detection line installed in the water when an anomalous body such as a submarine passes through the water, calculates a correlation coefficient between the disturbed signal detected in real time and a template in which disturbed signals for each position are calculated and stored in advance, finds a correlation coefficient having highest similarity, and determines a position of the anomalous body from the template.

### CROSS-REFERENCE TO RELATED APPLICATIONS

This application claims the priority of Korean Patent Application No. 10-2016-0142151 filed on Oct. 28, 2016, and all the benefits accruing therefrom under 35 U.S.C. § 119, the contents of which is incorporated by reference in its entirety.

### TECHNICAL FIELD

The present disclosure relates to an apparatus and a method for localizing an underwater anomalous body, and more particularly, to an apparatus and a method for localizing an underwater anomalous body, which detect, in real time, any one disturbed signal among a disturbed electric field, a disturbed magnetic field, and a disturbed gravity field by means of a detection line installed in the water when an anomalous body such as a submarine passes through the water, calculates a correlation coefficient between the disturbed signal detected in real time and a template in which the disturbed signals for each position are calculated and stored in advance, finds a correlation coefficient having highest similarity, and determines a position of the anomalous body from the template.

### BACKGROUND ART

In general, acoustic waves or electromagnetic waves are used to recognize a position of an unmanned midget submarine or submarine that travels in the water.

As a method which uses the acoustic waves among the methods of detecting an underwater object, there is provided an apparatus for detecting an underwater object disclosed in Korean Patent Application Laid-Open No. 1999-0078351.

However, the apparatus for detecting an underwater object by using the acoustic waves has a problem in that it is difficult to detect the underwater object by using the acoustic waves at a location where noise is high because of a strong tidal flow or a location where water layers, which have differences in temperature and salinity, are mixed.

As a method which uses the electromagnetic waves among the methods of detecting an underwater object, there is provided a mine detection system using electromagnetic waves disclosed in U.S. Pat. No. 5,598,152.

However, because the mine detection system using the electromagnetic waves sequentially detects mines as an underwater vehicle (AUV) is moved, the mine detection system is suitable to detect a stationary mine, but the mine detection system is not suitable to detect a moving object.

Therefore, to solve the problems with the prior patents, Korean Patent No. 1,521,473 has been made by Korea Institute of Geoscience and Mineral Resources, the applicant of the present disclosure. The patent granted to Korea Institute of Geoscience And Mineral Resources discloses an underwater detection apparatus capable of detecting a moving object even at a location where noise is high because of a strong tidal flow or a location where water layers, which have differences in temperature and salinity, are mixed. The underwater detection apparatus has a method and a system which detect an underwater object by artificially forming an electric field by applying electric current in the water, and measuring electric field disturbance when the electric field disturbance occurs due to the underwater object.

However, the method, which detects an anomalous body or an anomaly zone by using an electric field, similar to the patent granted to Korea Institute of Geoscience and Mineral Resources, or using a magnetic field, a gravity field, or the like, typically uses an inverse operation tracking method as a data processing method, but the inverse operation tracking method is performed based on iterative calculation, and as a result, it is impossible to track the anomalous body or the anomaly zone in real time because a large amount of time is required even though a high-speed computer is used. When submarines, which have three-dimensional shapes and different physical properties, are placed at any position in an underwater three-dimensional numerical modeling space above a seabed, the iterative inversion process cannot cope with the real-time tracking within one second.

### DISCLOSURE

### Technical Problem

The present disclosure has been made in an effort to solve the aforementioned problems in the related art, and an object of the present disclosure is to provide an apparatus and a method for localizing an underwater anomalous body which detect a disturbed signal such as an electric field, a magnetic field, or a gravity field by means of a detection line, which is fixed in the water in a sensor arrangement shape when an underwater anomalous body comes into a monitoring region, and inform of a position of the underwater anomalous body in real time.

In addition, another object of the present disclosure is to provide an apparatus and a method for localizing an underwater anomalous body which are capable of detecting and tracking the underwater anomalous body even in an environment in which it is difficult to perform acoustic detection because of severe acoustic noise, and capable of solving the problems in the related art in that various inverse operation algorithms require a large amount of calculation time and are not suitable to provide real-time positions.

### Technical Solution

To achieve the aforementioned objects, an apparatus for localizing an underwater anomalous body according to an exemplary embodiment of the present disclosure includes: a detection line which is installed in the form of a line in the water and outputs a disturbance detection signal corresponding to an underwater anomalous body when the underwater anomalous body approaches the detection line; a signal processing unit which is configured to receive, in real time, the detection signal from the detection line and filter the detection signal; a template comparison target range defining unit which is configured to analyze properties of the detection signal filtered by the signal processing unit and define a comparison target range of a template; a correlation coefficient calculating unit which is configured to recognize a disturbed signal by analyzing the detection signal, and calculate a correlation coefficient between the disturbed signal and the template of which the comparison target range is defined; and an anomalous body position determining unit which is configured to find a correlation coefficient having highest similarity among the correlation coefficients calculated by the correlation coefficient calculating unit, and determine a position of the anomalous body from the template in respect to the correlation coefficient.

In the apparatus for localizing the underwater anomalous body according to the exemplary embodiment, the detection line may be further configured to output any one disturbance detection signal among a disturbed electric field detection signal, a disturbed magnetic field detection signal, and a disturbed gravity field detection signal.

The apparatus for localizing the underwater anomalous body according to the exemplary embodiment may further include a display unit which is configured to display the position of the anomalous body which is determined by the anomalous body position determining unit.

In the apparatus for localizing the underwater anomalous body according to the exemplary embodiment, determination of the template may be performed by dividing a monitoring region into grids, calculating a disturbed signal according to a position of the anomalous body in the divided grids through computation modeling, and determining the calculated disturbed signal according to a position of the anomalous body in the divided grids as a template.

In the apparatus for localizing the underwater anomalous body according to the exemplary embodiment, the signal processing unit may be further configured to filter the detection signal by a curve fitting method.

In the apparatus for localizing the underwater anomalous body according to the exemplary embodiment, the signal processing unit may be further configured to filter the detection signal by using a Kalman filter.

In the apparatus for localizing the underwater anomalous body according to the exemplary embodiment, the template comparison target range defining unit may be further configured to recognize the disturbed signals by analyzing the detection signal, designate an x-axis position range (parallel to the detection line) in accordance with a maximum value of the disturbed signals, and designate a y-axis range (orthogonal to the detection line) and a z-axis range (height) by using a ratio between a width and the maximum value of the disturbed signals.

To achieve the aforementioned objects, a method of localizing an underwater anomalous body according to another exemplary embodiment of the present disclosure includes: receiving, by the signal processing unit, a disturbance detection signal in real time from the detection line and filtering the disturbance detection signal; analyzing, by the template comparison target range defining unit, properties of the detection signal filtered by the filtering of the detection signal and defining a comparison target range of the template; recognizing, by the correlation coefficient calculating unit, a disturbed signal by analyzing the detection signal, and calculating a correlation coefficient between the disturbed signal and the template in a range defined by the defining of the comparison target range; and finding, by the anomalous body position determining unit, a correlation coefficient having highest similarity among the correlation coefficients calculated by the calculating of the correlation coefficient, and determining a position of the anomalous body from the template in respect to the correlation coefficient.

The method of localizing the underwater anomalous body according to another exemplary embodiment may further include displaying, by a display unit, the position of the anomalous body which is determined by the determining of the position of the anomalous body.

In the method of localizing the underwater anomalous body according to another exemplary embodiment, determination of the template may be performed by dividing a monitoring region into grids, calculating a disturbed signal according to a position of the anomalous body in the divided grids through computation modeling, and determining the calculated disturbed signal according to a position of the anomalous body in the divided grids as a template.

In the method of localizing the underwater anomalous body according to another exemplary embodiment, the filtering of the detection signal may include filtering the detection signal by a curve fitting method.

In the method of localizing the underwater anomalous body according to another exemplary embodiment, the filtering of the detection signal may include filtering the detection signal by using a Kalman filter.

In the method of localizing the underwater anomalous body according to another exemplary embodiment, the defining of the comparison target range may include: recognizing the disturbed signal by analyzing the detection signal; designating an x-axis position range (parallel to the detection line) in accordance with a maximum value of the disturbed signals; and designating a y-axis range (orthogonal to the detection line) and a z-axis range (height) by using a ratio between a width and the maximum value of the disturbed signals.

### Effect

According to the apparatus and the method for localizing the underwater anomalous body according to the exemplary embodiment of the present disclosure, the signal processing unit receives, in real time, the disturbance detection signal from the detection line installed in the form of a line in the water and filters the disturbance detection signal, the template comparison target range defining unit analyzes properties of the detection signal filtered by the signal processing unit and defines a comparison target range of the template, the correlation coefficient calculating unit recognizes the disturbed signal by analyzing the detection signal and calculates the correlation coefficient between the disturbed signal and the template of which the comparison target range is defined, the anomalous body position determining unit finds the correlation coefficient having highest similarity among the correlation coefficients calculated by the correlation coefficient calculating unit and determines a position of the anomalous body from the template in respect to the correlation coefficient, and as a result, the apparatus and the method for localizing the underwater anomalous body according to the exemplary embodiment of the present disclosure are suitable to determine, in real time, a position of the underwater anomalous body in a particular monitoring region on the seabed, and thus it is possible to detect and track the anomalous body even in an environment in which it is difficult to perform deep-sea acoustic detection due to severe acoustic noise.

The present disclosure may solve the problem in the related art in that when submarines, which have three-dimensional shapes and different physical properties, are placed at any position in an underwater three-dimensional numerical value modeling space above a seabed, the iterative inverse operation numerical value calculation cannot cope with the real-time tracking within one second.

In particular, according to the apparatus and the method for localizing the underwater anomalous body according to the exemplary embodiment of the present disclosure, since the value template calculated in advance and the disturbed signal detected in real time are immediately compared with each other, such that high-speed data processing is enabled, and thus a position of the underwater anomalous body may be determined in real time.

### DESCRIPTION OF DRAWINGS

FIG. 1 is a view illustrating an example in which a detection line, which provides a disturbed electric field detection signal in an apparatus for localizing an underwater anomalous body according to an exemplary embodiment of the present disclosure, is installed at a particular location on a seabed.

FIG. 2 is a view illustrating an example of templates stored in a template storage unit of the apparatus for localizing the underwater anomalous body according to the exemplary embodiment of the present disclosure.

FIG. 3 is a control block diagram of the apparatus for localizing the underwater anomalous body according to the exemplary embodiment of the present disclosure.

FIG. 4 is a flowchart of a process of determining the template stored in the template storage unit of the apparatus for localizing the underwater anomalous body according to the exemplary embodiment of the present disclosure.

FIG. 5 is a flowchart for explaining a method of localizing an underwater anomalous body using the apparatus for localizing the underwater anomalous body according to the exemplary embodiment of the present disclosure.

FIG. 6A is a view illustrating a state in which a template, which is defined in a comparison target range, and a disturbed electric field, which is detected in real time in a small-scale model water tank experiment apparatus, are matched with each other.

FIG. 6B is a view illustrating a determined position of the anomalous body.

### BEST MODE

Hereinafter, an exemplary embodiment of the present disclosure will be described in detail with reference to the accompanying drawings.

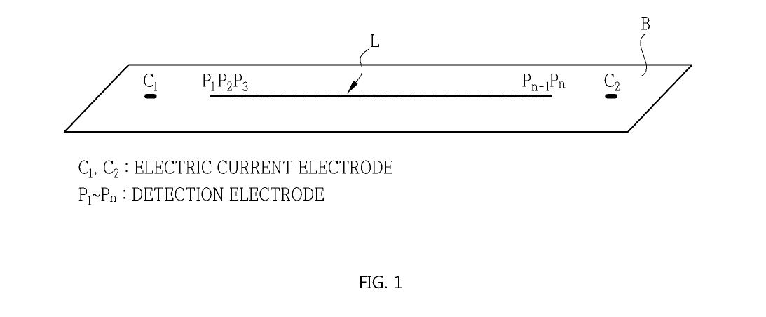

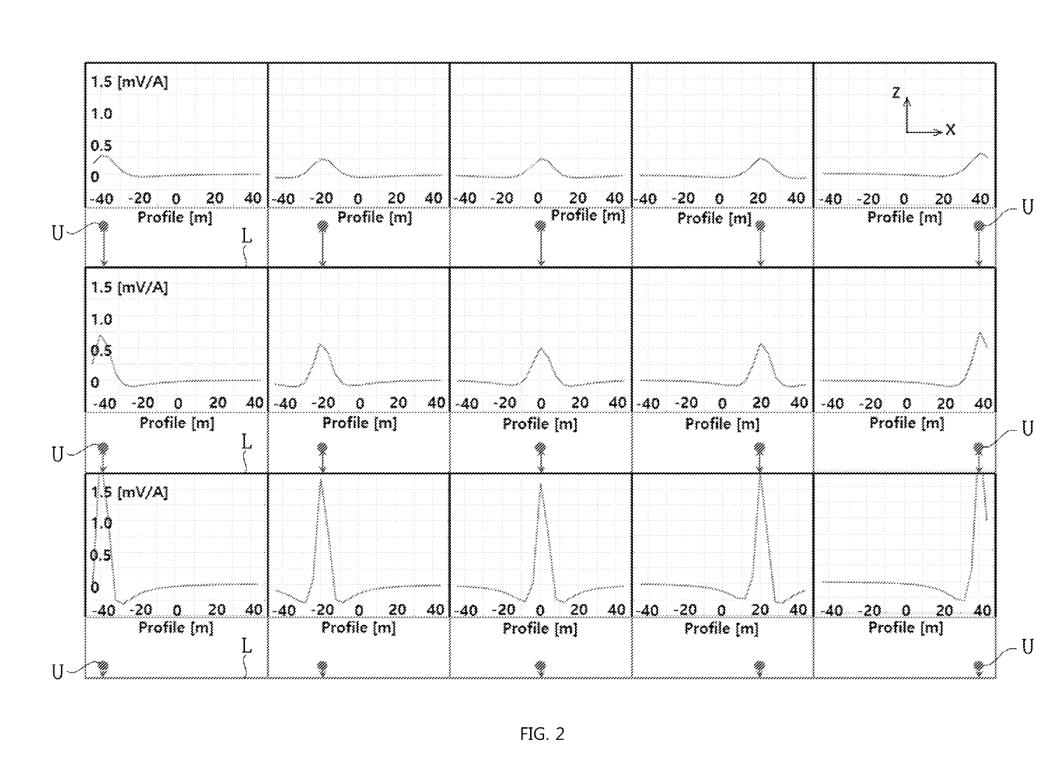

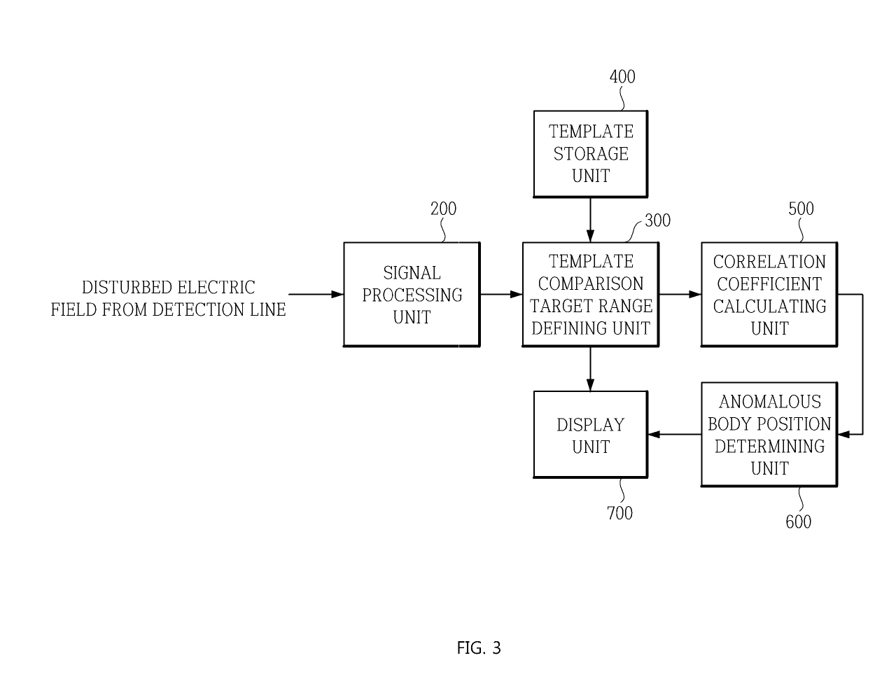

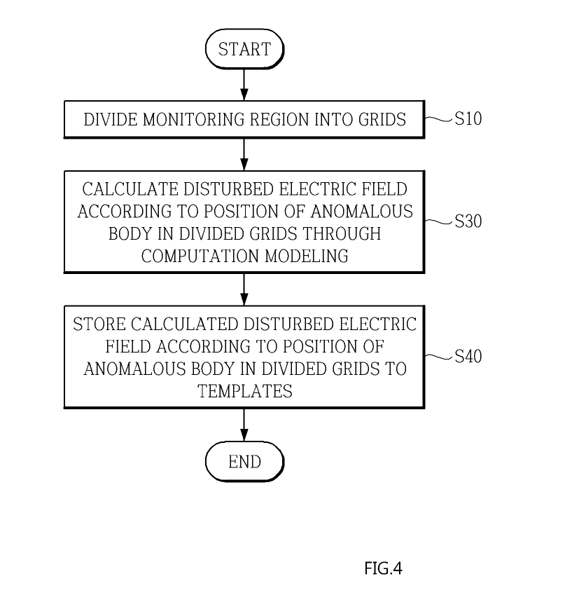

FIG. 1 is a view illustrating an example in which a detection line, which provides a disturbed electric field detection signal in an apparatus for localizing an underwater anomalous body according to an exemplary embodiment of the present disclosure, is installed at a particular location on a seabed, FIG. 2 is a view illustrating an example of templates stored in a template storage unit of the apparatus for localizing the underwater anomalous body according to the exemplary embodiment of the present disclosure, FIG. 3 is a control block diagram of the apparatus for localizing the underwater anomalous body according to the exemplary embodiment of the present disclosure, and FIG. 4 is a flowchart of a process of determining the template stored in the template storage unit of the apparatus for localizing the underwater anomalous body according to the exemplary embodiment of the present disclosure.

As illustrated in FIGS. 1 to 4, an apparatus for localizing an underwater anomalous body according to an exemplary embodiment of the present disclosure includes a detection line L, a signal processing unit 200, a template storage unit 400, a template comparison target range defining unit 300, a correlation coefficient calculating unit 500, an anomalous body position determining unit 600, and a display unit 700.

The detection line L is installed in the form of a line in the water (e.g., on a seabed B), and electric current is applied to the detection line L through electric current electrodes C₁ and C₂, such that when an underwater anomalous body such as a submarine approaches the detection line L, the detection line L serves to output a corresponding disturbed electric field detection signal. A plurality of detection electrodes P1, P2, P3 . . . Pn−1, and Pn is mounted on the detection line L in a longitudinal direction of the detection line L, and the disturbed electric field detection signal is outputted through the detection electrode L. As illustrated in FIG. 2, it can be seen that a narrower and larger value is outputted as an underwater anomalous body U is closer to the detection line L, and a wider and smaller value is outputted as an underwater anomalous body U is more distant from the detection line L.

The signal processing unit 200 serves to receive, in real time, the disturbed electric field detection signal from the detection line L, and to filter the disturbed electric field detection signal by using a curve fitting method or a Kalman filter. The curve fitting method is a method of estimating peripheral data based on given data. The filtering method using the Kalman filter enables optimum statistical estimation on a current state by estimating a current value based on a value which is estimated previously.

The template storage unit 400 stores templates to be compared with the disturbed electric fields which are detected in real time by the detection line L. The template comparison target range defining unit 300 receives the template from the template storage unit 400 and defines a comparison target range, and the template of which the comparison target range is defined is used for the correlation coefficient calculating unit 500 and the anomalous body position determining unit 600.

FIG. 4 is a flowchart illustrating a process of determining the template stored in the template storage unit 400 of the apparatus for localizing the underwater anomalous body according to the exemplary embodiment of the present disclosure, and in this case, S means a step.

In the process of determining the template, first, a monitoring region is divided into a plurality of grids (S10), the disturbed electric fields according to positions of the anomalous body in the divided grids are calculated through computation modeling (S30), the calculated disturbed electric fields according to the positions of the anomalous body in the divided grids are determined as the templates, and the templates are stored in the template storage unit 400 (S40).

The template comparison target range defining unit 300 serves to analyze properties of the disturbed electric field detection signal filtered by the signal processing unit 200, and to define a comparison target range of the template. In more detail, the comparison target range of the template is defined by analyzing the filtered disturbed electric field detection signal so as to recognize the disturbed electric fields, designating an x-axis position range (parallel to the detection line) in accordance with a maximum value of the disturbed electric fields, and designating a y-axis range (orthogonal to the detection line) and a z-axis range (height) by using a ratio between a width and the maximum value of the disturbed electric fields. As described above, it is possible to determine, in real time, a position of the underwater anomalous body by direct comparison with the value templates calculated in advance.

The correlation coefficient calculating unit 500 serves to recognize the disturbed electric field by analyzing the disturbed electric field detection signal filtered by the signal processing unit 200, and to calculate a correlation coefficient between the disturbed electric field and the template of which the comparison target range is defined by the template comparison target range defining unit 300. The disturbed electric field, which is detected in real time, and the template, which is calculated through the computation modeling, are similar to each other in aspect, but there is a level difference between the disturbed electric field and the template due to various errors such as a heterogeneous medium and an edge effect, and therefore, a correlation coefficient ρ between the two data is calculated.

The correlation coefficient ρ is defined by the following Equation 1.

$$ρ ( A , B ) = \frac{1}{N - 1} {\sum }_{i = 1}^{N} ( \frac{{A}_{i} - {m}_{A}}{{σ}_{A}} ) ( \frac{{B}_{i} - {m}_{B}}{{σ}_{B}} ) \qquad [ Equation 1 ]$$

A: disturbed electric field detected in real time

B: computation modeling data in respect to anomalous body at any position stored in template

m_{A}: average value of disturbed electric field detected in real time

m_{B}: average value of computation modeling data in respect to anomalous body at any position

σ_{A}: standard deviation of disturbed electric field detected in real time

ρ_{B}: standard deviation of computation modeling data in respect to anomalous body at any position.

N: number of detected disturbed electric fields

The anomalous body position determining unit 600 serves to find a correlation coefficient having highest similarity (closest to 1) among the correlation coefficients ρ calculated by the correlation coefficient calculating unit 500, and to determine a position of the anomalous body from the template in respect to the correlation coefficient.

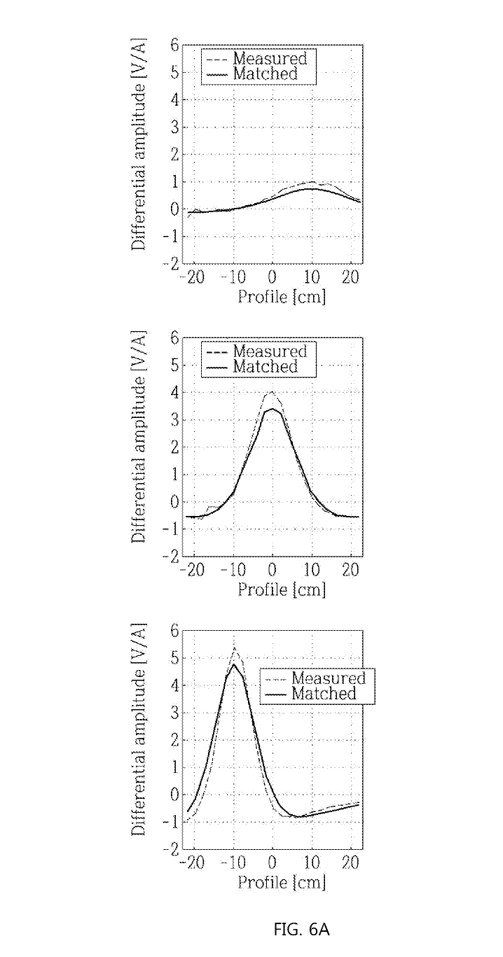

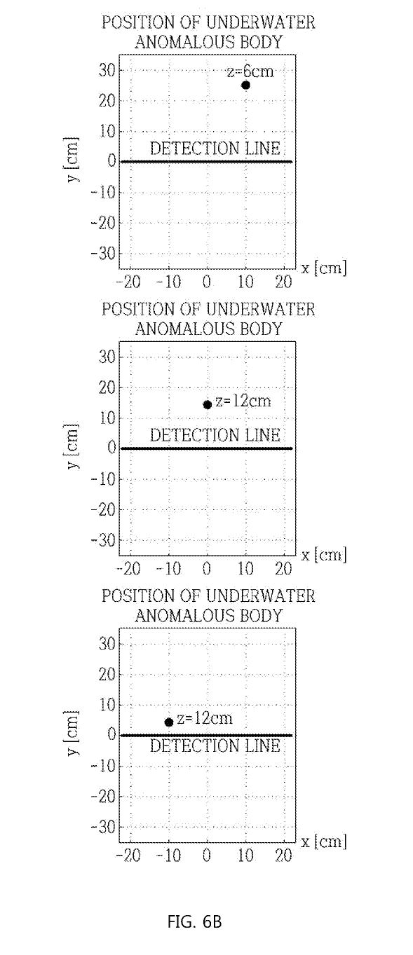

In FIG. 6A, a broken line indicates the disturbed electric field detected in real time, a solid line indicates the template of the correlation coefficient closest to “1”, and FIG. 6A illustrates a state in which the two values are matched.

FIG. 6B illustrates a position of the anomalous body based on the detection line of which the y value is “0”.

The display unit 700 serves to display a position of the anomalous body which is determined by the anomalous body position determining unit 600, and the display unit 700 may be an LCD, a CRT, an LED, or the like.

A method of localizing an underwater anomalous body using the apparatus for localizing the underwater anomalous body according to the exemplary embodiment of the present disclosure, which includes the aforementioned constituent elements, will be described with reference to the drawings.

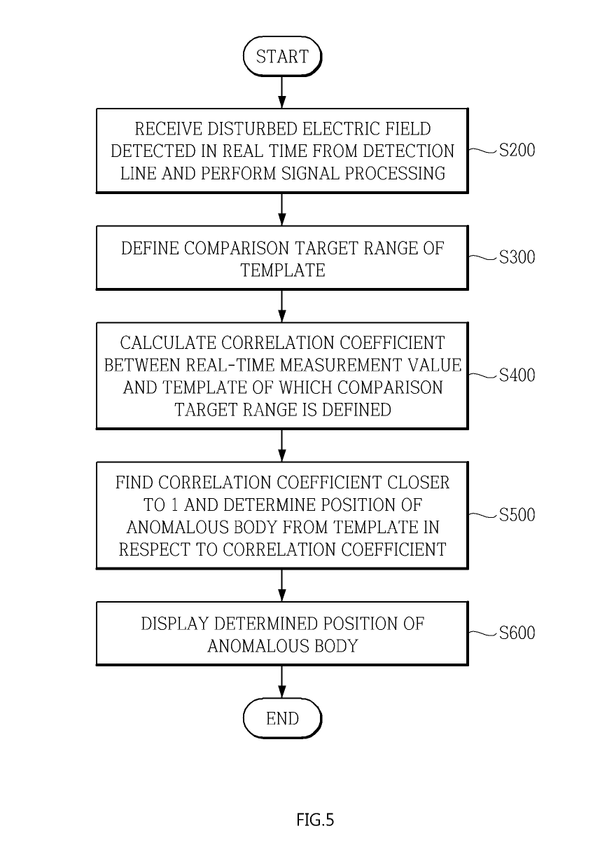

FIG. 5 is a flowchart for explaining the method of localizing the underwater anomalous body using the apparatus for localizing the underwater anomalous body according to the exemplary embodiment of the present disclosure, and in this case, S means a step.

First, the signal processing unit 200 receives, in real time, the disturbed electric field detection signal from the detection line L, and filters the disturbed electric field detection signal by using the curve fitting method or the Kalman filter (S200).

Subsequently, the template comparison target range defining unit 300 analyzes properties of the disturbed electric field detection signal filtered in step S200 and defines a comparison target range of the template (S300). In more detail, the comparison target range of the template is defined by analyzing the filtered disturbed electric field detection signal so as to recognize the disturbed electric fields, designating an x-axis position range (parallel to the detection line) in accordance with a maximum value of the disturbed electric fields, and designating a y-axis range (orthogonal to the detection line) and a z-axis range (height) by using a ratio between a width and the maximum value of the disturbed electric fields. As described above, it is possible to determine, in real time, a position of the underwater anomalous body by direct comparison with the value templates calculated in advance.

In step S400, the correlation coefficient calculating unit 500 recognizes the disturbed electric field by analyzing the disturbed electric field detection signal detected in real time, and calculates the correlation coefficient between the disturbed electric field and the templates of which the comparison target ranges are defined in step S300.

In step S500, the anomalous body position determining unit 600 finds a correlation coefficient having highest similarity (closest to 1) among the correlation coefficients calculated in step S400, and determines a position of the anomalous body from the template in respect to the correlation coefficient.

In step S600, a position of the anomalous body determined in step S500 is displayed through the display unit 700.

Meanwhile, the description has been generally made in a state in which the disturbed signal is assumed as the disturbed electric field, but this is just one exemplary embodiment, and it should be understood that the disturbed signal may be substantially substituted by a disturbed magnetic field or a disturbed gravity field.

Meanwhile, the aforementioned description discloses an example in which the detection line outputs the disturbed electric field detection signal, but it should be understood that the detection line may substantially output a disturbed magnetic field detection signal or a disturbed gravity field detection signal other than the disturbed electric field detection signal.

Meanwhile, the aforementioned description discloses an example in which the disturbed electric fields according to a position of the anomalous body in the divided grids are determined as the templates, but it should be understood that disturbed magnetic fields or disturbed gravity fields according to a position of the anomalous body in the divided grids may be substantially determined as the templates other than the disturbed electric fields according to a position of the anomalous body in the divided grids.

According to the apparatus and the method for localizing the underwater anomalous body according to the exemplary embodiment of the present disclosure which is configured as described above, the signal processing unit receives, in real time, the disturbance detection signal from the detection line installed in the form of a line in the water and filters the disturbance detection signal, the template comparison target range defining unit analyzes properties of the detection signal filtered by the signal processing unit and defines a comparison target range of the template, the correlation coefficient calculating unit recognizes the disturbed signal by analyzing the detection signal and calculates the correlation coefficient between the disturbed signal and the template of which the comparison target range is defined, the anomalous body position determining unit finds the correlation coefficient having highest similarity (closest to 1) among the correlation coefficients calculated by the correlation coefficient calculating unit and determines a position of the anomalous body from the template in respect to the correlation coefficient, and as a result, the apparatus and the method for localizing the underwater anomalous body according to the exemplary embodiment of the present disclosure are suitable to determine, in real time, a position of the underwater anomalous body in a particular monitoring region on the seabed, and thus it is possible to detect and track the anomalous body even in an environment in which it is difficult to perform deep-sea acoustic detection due to severe acoustic noise.

In particular, the template comparison target range defining unit analyzes properties of the disturbed signal detected in real time and defines the comparison target range of the template, thereby decreasing a range of the template to be compared with the disturbed signal detected in real time, such that high-speed data processing is enabled, and thus a position of the underwater anomalous body may be determined in real time.

The optimum exemplary embodiment is disclosed and the specific terms are used in the drawings and the specification, but the exemplary embodiment and the terms are used just for the purpose of explaining the exemplary embodiment of the present disclosure, but not used to limit meanings or restrict the scope of the present disclosure disclosed in the claims. Therefore, those skilled in the art will understand that various modifications of the exemplary embodiment and any other exemplary embodiment equivalent thereto are available. Accordingly, the true technical protection scope of the present disclosure should be determined by the technical spirit of the appended claims.

### DESCRIPTION OF REFERENCE NUMERALS

100: Detection signal input unit
200: Signal processing unit
300: Template comparison target range defining unit
400: Template storage unit
500: Correlation coefficient calculating unit
600: Anomalous body position determining unit
700: Display unit

1. An apparatus for localizing an underwater anomalous body, the apparatus comprising:
a detection line which is installed in the form of a line in the water and outputs a disturbance detection signal corresponding to an underwater anomalous body when the underwater anomalous body approaches the detection line;
a signal processing unit which is configured to receive, in real time, the detection signal from the detection line and filter the detection signal;
a template comparison target range defining unit which is configured to analyze properties of the detection signal filtered by the signal processing unit and define a comparison target range of a template;
a correlation coefficient calculating unit which is configured to recognize a disturbed signal by analyzing the detection signal, and calculate a correlation coefficient between the disturbed signal and the template in the range defined by the template comparison target range defining unit; and
an anomalous body position determining unit which is configured to find a correlation coefficient closest to 1 among the correlation coefficients calculated by the correlation coefficient calculating unit, and determine a position of the anomalous body from the template in respect to the correlation coefficient.

2. The apparatus of claim 1, wherein the detection line is further configured to output any one disturbance detection signal among a disturbed electric field detection signal, a disturbed magnetic field detection signal, and a disturbed gravity field detection signal.

3. The apparatus of claim 1, further comprising:
a display unit which is configured to display the position of the anomalous body which is determined by the anomalous body position determining unit.

4. The apparatus of claim 1, wherein determination of the template is performed by dividing a monitoring region into grids, calculating a disturbed signal according to a position of the anomalous body in the divided grids by numerical modeling, and determining the calculated disturbed signal according to a position of the anomalous body in the divided grids as a template.

5. The apparatus of claim 1, wherein the signal processing unit is further configured to filter the detection signal by a curve fitting method.

6. The apparatus of claim 1, wherein the signal processing unit is further configured to filter the detection signal by using a Kalman filter.

7. The apparatus of claim 1, wherein the template comparison target range defining unit is further configured to recognize the disturbed signals by analyzing the detection signal, designate an x-axis position range (parallel to the detection line) in accordance with a maximum value of the disturbed signals, and designate a y-axis range (orthogonal to the detection line) and a z-axis range (height) by using a ratio between a width and the maximum value of the disturbed signals.

8. A method of localizing an underwater anomalous body which uses the apparatus for localizing the underwater anomalous body according to claim 1, the method comprising:
receiving, by the signal processing unit, a disturbance detection signal in real time from the detection line and filtering the disturbance detection signal;
analyzing, by the template comparison target range defining unit, properties of the detection signal filtered by the filtering of the detection signal and defining a comparison target range of the template;
recognizing, by the correlation coefficient calculating unit, a disturbed signal by analyzing the detection signal, and calculating a correlation coefficient between the disturbed signal and the template in a range defined by the defining of the comparison target range; and
finding, by the anomalous body position determining unit, a correlation coefficient closest to 1 among the correlation coefficients calculated by the calculating of the correlation coefficient, and determining a position of the anomalous body from the template in respect to the correlation coefficient.

9. The method of claim 8, further comprising:
displaying, by a display unit, the position of the anomalous body which is determined by the determining of the position of the anomalous body.

10. The method of claim 8, wherein determination of the template is performed by dividing a monitoring region into grids, calculating a disturbed signal according to a position of the anomalous body in the divided grids by numerical modeling, and determining the calculated disturbed signal according to a position of the anomalous body in the divided grids as a template.

11. The method of claim 8, wherein the filtering of the detection signal includes filtering the detection signal by a curve fitting method.

12. The method of claim 8, wherein the filtering of the detection signal includes filtering the detection signal by using a Kalman filter.

13. The method of claim 8, wherein the defining of the comparison target range includes:
recognizing the disturbed signal by analyzing the detection signal;
designating an x-axis position range (parallel to the detection line) in accordance with a maximum value of the disturbed signals; and
designating a y-axis range (orthogonal to the detection line) and a z-axis range (height) by using a ratio between a width and the maximum value of the disturbed signals.
